(19) United States
(12) Patent Application Publication
(10) Pub. No.: US 2010/0208627 A1
(43) Pub. Date: Aug. 19, 2010

(54) WIRELESS INTERNET ACCESS REPEATER

(76) Inventor: Nam-kyu CHO, Hwaseong-si (KR)

Correspondence Address: North Star Intellectual Property Law, PC, P.O. Box 34688, Washington, DC, 20043, US

(21) Appl. No.: 12/561,284

(22) Filed: Sep. 17, 2009

(30) Foreign Application Priority Data
Feb. 13, 2009 (KR) 10-2009-0011985

(51) Int. Cl. H04B 7/14; H04J 3/08

(52) U.S. Cl. 370/279; 370/315

(57) ABSTRACT

Provided is a wireless Internet access repeater which can perform signal transmission and reception between a short-range wireless communication (Wi-Fi) baseband signal and a wide area wireless communication (WiMAX) baseband signal without a Ethernet physical layer protocol (PHY). The wireless Internet access repeater includes a wide area wireless communication module; a short-range wireless communication module; a first media access control (MAC) processing unit and a second MAC processing units, wherein the first MAC processing unit processes transmitted and received data according to a protocol of a MAC layer in a wide area wireless communication module and a second MAC processing unit processes transmitted and received data according to a protocol of a MAC layer in the short-range wireless communication module; a first media independent interface (MII) unit and a second MII unit, wherein the first MII unit interfaces data in the wide area wireless communication module interfaces data transmitted and received between the first and second MAC processing units and is the second MII unit in the short-range wireless communication module interfaces the data transmitted and received between the first and second MAC processing units; and a clock provider to provide a clock to the first and second MII units.

### CROSS REFERENCE TO RELATED APPLICATION

This application claims the benefit under 35 U.S.C. §119(a) of Korean Patent Application No. 10-2009-0011985, filed on Feb. 13, 2009, the disclosure of which is incorporated herein in its entirety by reference.

### BACKGROUND

1. Field

The following description relates to a wireless Internet access repeater, and more particularly, to a wireless Internet access repeater which can perform signal transmission and reception between a short-range wireless communication (Wi-Fi) baseband signal and a wide area wireless communication (WiMAX) baseband signal without an Ethernet physical layer protocol (PHY).

2. Description of the Related Art

In line with the development of communication technologies and mobile terminal related technologies, a variety of communication methods have been developed and introduced. Among such communication technologies, Wi-Fi technology, which is referred to as a wireless local area network (WLAN), is a short-range communication technology using radio wave. Wi-Fi allows wireless data transmission/reception at a relatively low cost, but it has limitations in speed and range.

To overcome such drawbacks, wide area wireless Internet access services such as Wibro and WiMAX have been developed. WiMAX, which is based on the Institute of Electrical and Electronics Engineers (IEEE) 802.16d/e standard, provides high-speed Internet access to a terminal, using frequency bands of 2.3 GHz, 2.5 GHz, 3.5 GHz, or 5 GHz while the terminal is moving at a moderate speed (up to 120 km). For reference, a terminal employing a wide area wireless communication module such as WiMAX performs wireless communication with a base station, and afterwards is connected to the Internet network via the base station in either a wired or wireless fashion.

Although WiMAX may be considered more beneficial than WLAN technology in terms that WiMAX has better mobility at a high speed and no limitation in range, a terminal compatible only with WLAN cannot use a WiMAX or Wibro service normally. In this regard, a wireless Internet access apparatus or a wireless Internet access repeater has been developed to allow WLAN terminals to access a Wibro or WiMAX service network. Such wireless Internet access repeaters includes a short-range wireless communication (Wi-Fi) module and a wide area wireless communication (WiMAX) module, and the Wi-Fi module and the WiMAX module are connected together through the respective medial independent interfaces (MII) as shown in FIG. 1.

Specifically, a general wireless Internet access repeater including the Wi-Fi module and the WiMAX module has PHYs 110 and 120 at each MII module 100 and 130 as shown in FIG. 1. Such redundant use of the same components causes increase of cost and, moreover, can impede miniaturization which is a crucial characteristic of a portable device. Accordingly, a new solution for overcoming the above disadvantages is required.

Furthermore, the general wireless Internet access repeater including the WiFi module and the WiMAX module uses two antennas for the WiMAX module and a one or two antennas for the Wi-Fi module. Thus, if a wireless Internet access repeater can function properly with a reduced number of antennas, then a corresponding product can be further miniaturized and produced at a lower cost.

The wireless Internet access repeater may further include a second RF switch which is connected between the duplexer and the RF transmitting/receiving unit of the short-range wireless communication module and switches a transmitting/receiving path of an RF signal and a signal interference cancellation filter which is connected between the second RF switch and the RF transmitting/receiving unit of the short-range wireless communication module and cancels interference on a signal for wide area wireless communication.

### SUMMARY

Accordingly, in one aspect, there is provided a wireless Internet access repeater which can normally perform signal transmission and reception between a short-range wireless communication module and a wide area wireless communication module without an Ethernet physical layer protocol (PHY).

In addition, in another aspect, there is provided a wireless Internet access repeater which is simple and compact and can be produced at low cost by removing an Ethernet PHY for signal transmission/reception between a short-range wireless communication module and a wide area wireless communication module.

Also, in another aspect, there is provided a wireless Internet access repeater that can minimize the number of antennas for a short-range wireless communication and a wide area wireless communication.

According to one aspect, there is provided a wireless Internet access repeater including a wide area wireless communication module; a short-range wireless communication module; a first media access control (MAC) processing unit and a second MAC processing units, wherein the first MAC processing unit processes transmitted and received data according to a protocol of a MAC layer in a wide area wireless communication module and a second MAC processing unit processes transmitted and received data according to a protocol of a MAC layer in the short-range wireless communication module; a first media independent interface (MII) unit and a second MII unit, wherein the first MII unit interfaces data in the wide area wireless communication module interfaces data transmitted and received between the first and second MAC processing units and the second MII unit in the short-range wireless communication module interfaces the data transmitted and received between the first and second MAC processing units; and a clock provider to provide a clock to the first and second MII units.

The wireless Internet access repeater may further include a common antenna for wide area wireless communication and short-range wireless communication and a duplexer to divide signals receivable through the common antenna into signals for the wide area wireless communication module and signals for the short-range wireless communication module.

The first and second MAC processing units may exchange a control protocol message with each other to set or obtain particular information of a corresponding MAC processing unit of the other one of the wide area wireless communication module and the short-range wireless communication module.

The control protocol message may include at least three subfields of a packet data unit (PDU) type subfield that defines a type of a message, a sequence number subfield that specifies the order of transmitting messages, an error status information subfield, a PDU length information subfield and a PDU payload subfield, and a checksum subfield.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a diagram illustrating a connection between a short-range wireless communication (Wi-Fi) module and a wide area wireless communication (WiMAX) module through media independent interfaces (MIIs) in a general wireless Internet access repeater.

FIG. 2 is a block diagram illustrating a wireless Internet access repeater according to an exemplary embodiment.

FIG. 3 is a diagram illustrating a connection between MII units of each of a short-range wireless communication (Wi-Fi) module and a wide area wireless communication (WiMAX) module of FIG. 2.

FIG. 4 is a table illustrating format configuration of the control protocol message according to an exemplary embodiment.

FIG. 5 is a table for explaining a type of a packet data unit (PDU) of FIG. 4.

FIG. 6 is a table illustrating pieces of information contained in a PDU payload subfield of FIG. 4.

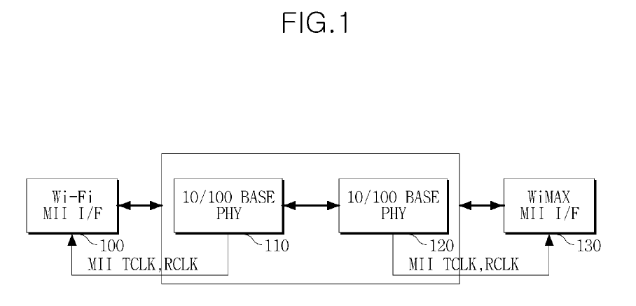

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

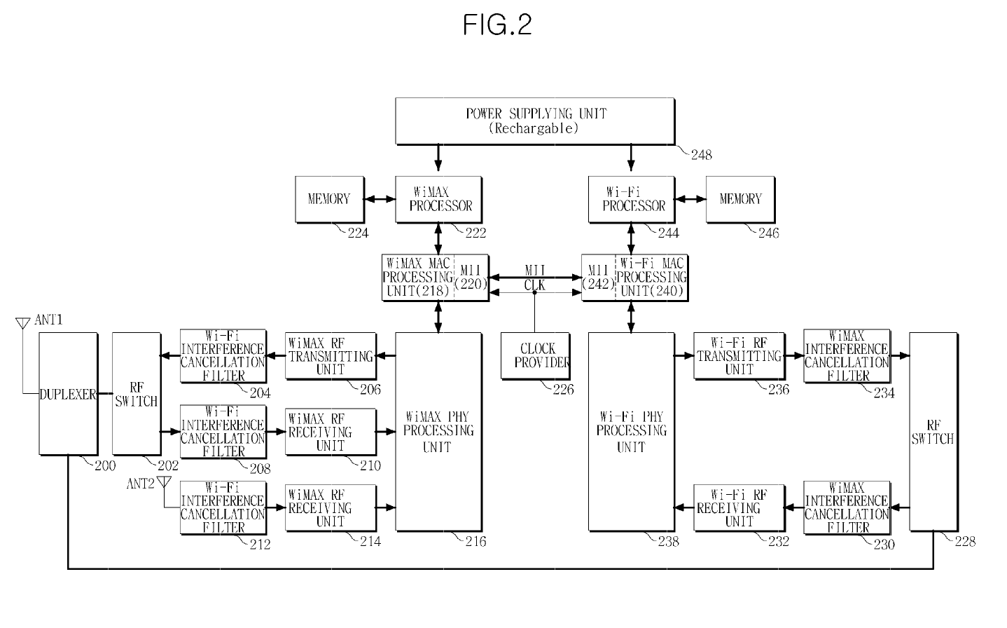

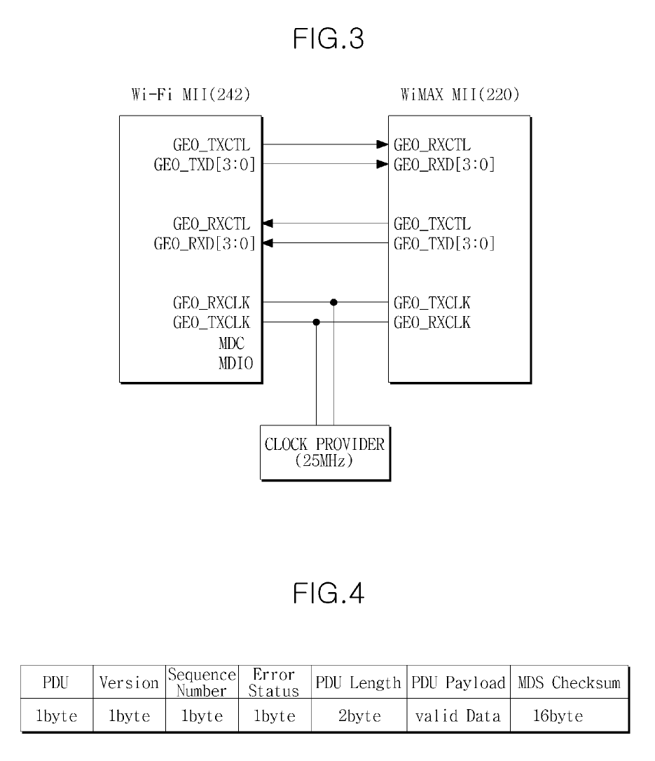

According to the present embodiment, a (portable) wireless Internet access repeater includes a local wireless communication (Wi-Fi) module which complies with one of the Institute of Electrical and Electronics Engineers (IEEE) 802.11 and IEEE802.16 communication standards, and thus can access a mobile terminal. In addition, the wireless Internet access repeater includes a wide area wireless communication (WiMAX) module which is based on, for example, IEEE802.16e technology which is different from wireless local area network (LAN) protocol, and thus can access wireless wide area network. The wireless Internet access repeater is to support terminals accessible to a wireless LAN to access the Internet network over a wireless wide area network. A configuration of the wireless Internet access repeater will be described with reference to FIGS. 2 and 3.

FIG. 2 is a block diagram illustrating a wireless Internet access repeater according to an exemplary embodiment. FIG. 3 is a diagram illustrating a connection between a second MII unit 242 of a short-range wireless communication (Wi-Fi) module and a first MII unit 220 of a wide area wireless communication (WiMAX) module of FIG. 2. The wireless Internet access repeater primarily includes a wide area wireless communication module and a short-range wireless communication module, a common antenna ANTI for wide area wireless communication and short-range wireless communication, and a power supplying unit 248 including a rechargeable battery to provide system power.

Referring to FIG. 2, the common antenna ANTI is an antenna of a time division duplex (TDD) type for wide area wireless communication and short-range wireless communication, and is used to transmit and receive wide area wireless communication signals in 2.3 GHz range and short-range wireless communication signals in 2.4 GHz range. A duplexer 200 divides signals receivable by the common antenna ANTI and outputs the signals through a wide area wireless communication (WiMAX) module and a short-range wireless communication (Wi-Fi) module. A first radio frequency (RF) switch 202 is connected between the duplexer 200 and a WiMAX RF transmitting unit 206 and a WiMAX RF receiving unit 210 to switch a transmitting/receiving path of an RF signal. The RF switch 202 is activated at a cycle determined by a first media access control (MAC) processing unit 218.

Wi-Fi interference cancellation filters, i.e., signal interference cancellation filters 204 and 208 between the first RF switch 202 and the WiMAX RF transmitting and receiving units 206 and 201 cancel interference in a signal for short-range wireless communication (Wi-Fi). The WiMAX RF transmitting and receiving units 206 and 210 placed at the rear of the signal interference cancellation filters 204 and 208 respectively transmit and receive an RF signal for wide area wireless communication. The WiMAX RF transmitting and receiving units 206 and 210 each include a filter for signal processing, a low-noise amplifier (LNA), a public address

(PA), and a MODEM to modulate and demodulate transmission/reception signals according to corresponding wireless communication standards.

A physical layer protocol (PHY) processing unit 216 of the wide area wireless communication (WiMAX) module processes transmission/reception data according to a protocol of a PHY layer specified by wide area wireless communication (WiMAX) standards and outputs the processed data. The first MAC processing unit 218 for WiMAX processes transmission/reception data according to a protocol of a MAC layer. However, in the current embodiment, the first MAC processing unit 218 for WiMAX performs data transmission and reception with a second MAC processing unit 240 for Wi-Fi through a first MII unit 220, and sets particular information (e.g., an AP mode, a wide area network (WAN) Internet protocol (IP)) of the second MAC processing unit 240 or obtains particular information (e.g., configuration identifier (ID)) by exchanging newly defined control protocol messages.

The first and second MII units 220 and 242 interface data transmitted and received between the first and second MAC processing units 218 and 240 of the respective WiMAX module and the Wi-Fi module. Connection between the first and second MII units 220 and 242 is shown in FIG. 3. As shown in FIG. 3, the first and second MAC processing units 218 and 240 for the WiMAX and Wi-Fi directly transmit and receive data therebetween using the respective first and second MII units 220 and 242 without having the data passed through an Ethernet PHY. In addition, the first MII unit 220 for WiMAX and the second MII unit 242 for Wi-Fi have their control (CTL) and data (D) transmission/reception terminals TX and RX cross-connected to each other, and a clock (CLK) is provided by an external clock provider 226.

A WiMAX processor 222 manages and controls items required for communication through the wide area wireless communication module. For example, the WiMAX processor 222 generally manages authentication/accounting information necessary for the wide area wireless communication. A memory 224 controlled by the WiMAX processor 222 may be divided into a buffer memory and a program storage memory, and various types of control program data required for wide area wireless communication and authentication/accounting data are stored in designated areas.

An antenna ANT2, a Wi-Fi interference cancellation filter 212 and a WiMAX RF receiving unit 214, which have not yet been described, are elements for implementing multi input multi output (MIMO) which is specified as a standard in wide area wireless communication standards. The configurations of these elements are the same as those of the above-described elements and thus the description thereof will not be reiterated.

Hereinafter, the short-range wireless communication (Wi-Fi) module will now be described with reference to FIG. 2.

An RF switch 228 of the Wi-Fi module is connected between the duplexer 200 and an RF transmitting and receiving units 236 and 232 of the Wi-Fi module to switch a transmitting/receiving path of an RF signal. The RF switch 228 is activated at a cycle determined by a second MAC processing unit 240. WiMAX interference cancellation filters, i.e., signal interference cancellation filters 230 and 234 connected between the RF switch 228 and the RF transmitting and receiving units 236 and 232 are used to cancel the interference in the wireless wide area signal. The Wi-Fi RF transmitting and receiving units 236 and 232 placed at the rear of the interference cancellation filters 234 and 230 respectively transmit and receive a RF signal for a short-range wireless signal.

A PHY processing unit 238 of the wireless short-range communication (Wi-Fi) module processes transmission/reception data according to a protocol of the PHY layer defined by the short-range wireless communication (Wi-Fi) standards, and outputs the processed signal, and the Wi-Fi MAC processing unit 240 processes transmission/reception data according to a protocol of the MAC layer. As described above, the Wi-Fi MAC processing unit 240 transmits and receives data on a control protocol message to/from the WiMAX MAC processing unit 218 through the second MII unit 242, and the second MII unit 242 interfaces data to be transmitted and received to/from the MII unit 220 in the first MAC processing unit 218 of the wide area wireless communication (WiMAX) module. A Wi-Fi processor 244 uses the short-range wireless communication module to manage elements necessary for wireless communication, and a memory 246 controlled by the Wi-Fi processor 244 is divided into a buffer memory and a storage memory to store various pieces of program data required for short-range wireless communication in designated areas.

Since the wireless Internet access repeater configured as described above has the RF switch 228 of the short-range wireless communication (Wi-Fi) module which is connected with the duplexer 200 of the wide area wireless communication (WiMAX) module, the wireless

Internet access repeater can transmit and receive short-range wireless and wide area wireless communication signals through the common antenna ANTI. Therefore, the wireless Internet access repeater according to the exemplary embodiment can have fewer antennas, compared to a conventional wireless Internet access repeater which transmits and receives short-range wireless signals and wide area wireless signals through the respective antennas.

Procedures of transmitting and receiving a control protocol message through the first and second MII units 220 and 242 will now be described in more detail.

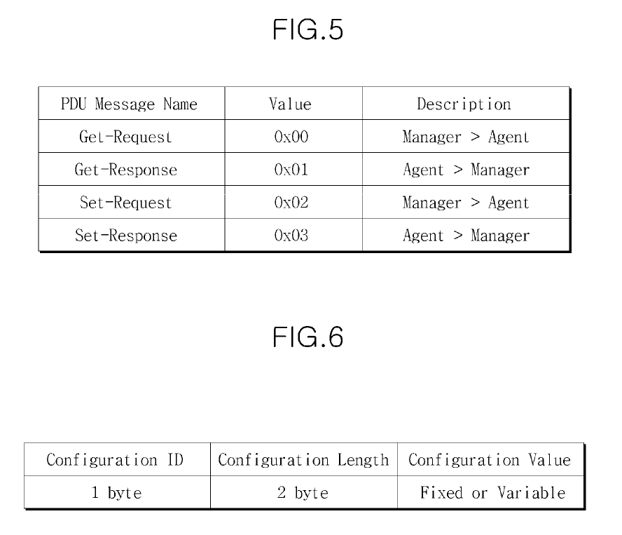

FIG. 4 is a table illustrating format configuration of the control protocol message according to an exemplary embodiment. FIG. 5 is a table for explaining a type of a packet data unit (PDU) in FIG. 4, and FIG. 6 is a table illustrating pieces of information contained in a PDU payload subfield of FIG. 4.

In the wireless Internet access repeater, only data is transmitted and received between the WiMAX MAC processing unit 218 and the Wi-Fi MAC processing unit 240 through the corresponding MII units 220 and 242. Accordingly, in the current exemplary embodiment, the control protocol message is newly defined, and the first and second MAC processing units 218 and 240 are configured to set particular information of a corresponding MAC processing unit 218 or 240 of the other one of the wide area wireless communication module and the short-range wireless communication module, such as transmission power, IP change, security setting, and a network name, or to obtain particular information by exchanging the newly defined control protocol message.

As shown in FIG. 4, the newly defined control protocol message includes a PDU type subfield of one byte specifying a message type, a version subfield of one byte for version management, a sequence number subfield of one byte indicating the transmission order (increase by one), an error status subfield of one byte indicating an error or abnormal status, a PDU length information subfield of two bytes indicating a length of a message, a PDU payload subfield of variable size into which configuration content is inserted, and a checksum subfield. The control protocol message, which may be referred to as a control PUD message, may have a maximum size of 1460 bytes.

For further information, if a type of the control protocol message is Get-Request, the payload subfield includes a requested configuration ID, a length of an information structure corresponding to the configuration ID, and a value of 0x00 as a configuration value. If a type of the control protocol message is Set-Request, the payload subfield includes a requested configuration ID, a length of an information structure, and a configuration value which is related to a setting to be changed in an AP. If a type of the control protocol message is Get-Response, the control protocol message includes a configuration ID requested to be read by a manager and 0x0000 as a configuration length, but without including a configuration value, and is transmitted to the opposite MAC processing unit. If a type of the control protocol message is Set-Response, the control protocol message includes a configuration ID that is requested to be written by a manager, a length of an information structure corresponding to the configuration ID, and a configuration value changed by an agent, and the control protocol message is transferred.

As described above, the first and second MAC processing units 218 and 240 use the newly defined control protocol message to set particular information of the opposite MAC processing unit or obtain specific information, and thus normal signal interface between the Wi-Fi MAC processing unit 240 and the WiMAX MAC processing unit 218 can be implemented only with the MII units 220 and 240, without additional control interfaces.

Accordingly, a wireless Internet access repeater according to the exemplary embodiment can perform signal transmission/reception normally by use of MII units of a Wi-Fi MAC processing unit and a WiMAX MAC processing unit without Ethernet PHY for signal communication between a short-range wireless communication (Wi-Fi) module and a wide area wireless communication (WiMAX) module. As the result, without Ethernet PHY, a simple and compact product can be implemented, and a battery can be mounted instead, thereby providing a mobile and low-priced product.

Furthermore, since the wireless Internet access repeater according to the exemplary embodiment uses a common antenna for a short-range wireless communication and a wide area wireless communication and only adds relevant electrical elements, the number of antennas to be used for the wireless Internet access repeater can be minimized. Consequently, miniaturization and a reduction in production cost of a product can be achieved.

A number of exemplary embodiments have been described above. Nevertheless, it will be understood that various modifications may be made. For example, even if 802.11n which is Wi-Fi MIMO technology is employed in the future, a wireless Internet access repeater with only two antennas like the exemplary embodiment can be implemented by only adding one more duplexer. Accordingly, other implementations are within the scope of the following claims.

What is claimed is:

1. A wireless Internet access repeater comprising:
a wide area wireless communication module;
a short-range wireless communication module;
a first media access control (MAC) processing unit and a second MAC processing units, wherein the first MAC processing unit processes transmitted and received data according to a protocol of a MAC layer in a wide area wireless communication module and a second MAC processing unit processes transmitted and received data according to a protocol of a MAC layer in the short-range wireless communication module;
a first media independent interface (MII) unit and a second MII unit, wherein the first MII unit interfaces data in the wide area wireless communication module interfaces data transmitted and received between the first and second MAC processing units and the second MII unit in the short-range wireless communication module interfaces the data transmitted and received between the first and second MAC processing units; and
a clock provider to provide a clock to the first and second MII units.

2. The wireless Internet access repeater of claim 1, wherein each of the wide area wireless communication module and the short-range wireless communication module complies with at least one of the Institute of Electrical and Electronics Engineers (IEEE) 802.11 communication standard and IEEE802.16 communication standard.

3. The wireless Internet access repeater of claim 1, wherein the first and second MAC processing units exchange control protocol messages with each other to set or obtain particular information of a corresponding MAC processing unit of the other one of the wide area wireless communication module and the short-range wireless communication module.

4. The wireless Internet access repeater of claim 1, further comprising:
a common antenna for wide area wireless communication and short-range wireless communication; and
a duplexer to divide signals receivable through the common antenna into signals for the wide area wireless communication module and signals for the short-range wireless communication module.

5. The wireless Internet access repeater of claim 4, wherein each of the wide area wireless communication module and the short-range wireless communication module complies with at least one of IEEE802.11 and IEEE802.16 communication standards.

6. The wireless Internet access repeater of claim 4, wherein the first and second MAC processing units exchange control protocol messages with each other to set or obtain particular information of a corresponding MAC processing unit of the other one of the wide area wireless communication module and the short-range wireless communication module.

7. The wireless Internet access repeater of claim 4, further comprising:
a first radio frequency (RF) switch which is connected between the duplexer and a radio frequency (RF) transmitting/receiving unit of the wide area wireless communication module and switches a transmitting/receiving path of an RF signal; and
a signal interference cancellation filter which is connected between the first RF switch and the RF transmission/receipt unit and cancels interference on a signal for short-range wireless communication.

8. The wireless Internet access repeater of claim 7, further comprising:
a second RF switch which is connected between the duplexer and the RF transmitting/receiving unit of the short-range wireless communication module and switches a transmitting/receiving path of an RF signal; and
a signal interference cancellation filter which is connected between the second RF switch and the RF transmitting/receiving unit of the short-range wireless communication module and cancels interference on a signal for wide area wireless communication.

9. The wireless Internet access repeater of claim 8, wherein each of the wide area wireless communication module and the short-range wireless communication module complies with at least one of IEEE802.11 and IEEE802.16 communication standards.

10. The wireless Internet access repeater of claim 8, wherein the first and second MAC processing units exchange control protocol messages with each other to set or obtain particular information of a corresponding MAC processing unit of the other one of the wide area wireless communication module and the short-range wireless communication module.

11. The wireless Internet access repeater of claim 4, further comprising:
a second RF switch which is connected between the duplexer and the RF transmitting/receiving unit of the short-range wireless communication module and switches a transmitting/receiving path of an RF signal; and
a signal interference cancellation filter which is connected between the second RF switch and the RF transmitting/receiving unit of the short-range wireless communication module and cancels interference on a signal for wide area wireless communication.

12. The wireless Internet access repeater of claim 11, wherein each of the wide area wireless communication module and the short-range wireless communication module complies with at least one of IEEE802.11 and IEEE802.16 communication standards.

13. The wireless Internet access repeater of claim 11, wherein the first and second MAC processing units exchange control protocol messages with each other to set or obtain particular information of a corresponding MAC processing unit of the other one of the wide area wireless communication module and the short-range wireless communication module.

14. The wireless Internet access repeater of claim 3, wherein the control protocol message includes at least three subfields of a packet data unit (PDU) type subfield that defines a type of a message, a sequence number subfield that specifies the order of transmitting messages, an error status information subfield, a PDU length information subfield and a PDU payload subfield, and a checksum subfield.

15. The wireless Internet access repeater of claim 14, wherein the PDU payload subfield includes configuration identifier that identifies whether setting of specific information is required, the length of corresponding configuration and a configuration value.

16. The wireless Internet access repeater of claim 6, wherein the control protocol message includes at least three subfields of a packet data unit (PDU) type subfield that defines a type of a message, a sequence number subfield that specifies the order of transmitting messages, an error status information subfield, a PDU length information subfield and a PDU payload subfield, and a checksum subfield.

17. The wireless Internet access repeater of claim 16, wherein the PDU payload subfield includes configuration identifier that identifies whether setting of specific information is required, the length of corresponding configuration and a configuration value.

18. The wireless Internet access repeater of claim 10, wherein the control protocol message includes at least three subfields of a packet data unit (PDU) type subfield that defines a type of a message, a sequence number subfield that specifies the order of transmitting messages, an error status information subfield, a PDU length information subfield and a PDU payload subfield, and a checksum subfield.

19. The wireless Internet access repeater of claim 18, wherein the PDU payload subfield includes configuration identifier that identifies whether setting of specific information is required, the length of corresponding configuration and a configuration value.

20. The wireless Internet access repeater of claim 13, wherein the control protocol message includes at least three subfields of a packet data unit (PDU) type subfield that defines a type of a message, a sequence number subfield that specifies the order of transmitting messages, an error status information subfield, a PDU length information subfield and a PDU payload subfield, and a checksum subfield.
